(19) United States
(12) Patent Application Publication
(10) Pub. No.: US 2005/0249849 A1
(43) Pub. Date: Nov. 10, 2005

(54) Re-sizable container

(76) Inventors: Menkin Nelson, Tonasket, WA (US); Christopher W. Oschek, Klamath Falls, OR (US)

Correspondence Address: Eastman & Associates, Suite 1800, 707 Broadway Street, San Diego, CA, 92101, US

(21) Appl. No.: 10/841,715

(22) Filed: May 6, 2004

(51) Int. Cl. A23B 4/00

(52) U.S. Cl. 426/394

(57) ABSTRACT

A re-sizable container includes a bottom that is formed with one or more circumferential strips that may be removed from the container to separate a portion of the bottom thereby decreasing the volume of the bottom. The lid may be placed on original container, and also may be placed on the remaining portion of the bottom to seal the remaining product within the container while minimizing exposure to air, and decreasing any wasted space.

### FIELD OF THE INVENTION

The present invention relates general to storage containers. The present invention is more particularly, though not exclusively, useful as a container that can be made smaller as the contents of the container are consumed. The present invention is more particularly useful as a food container that may be made smaller as the food within the container is consumed.

### BACKGROUND OF THE INVENTION

Currently available containers typically include a bottom and are equipped with a top to seal the container. The bottoms of these containers are available in a variety of shapes, and are often used for the transport of products, such as food packaged and made available in a store. Some containers are provided with a resealable top that allows the removal of a portion of the product within a container, and then the resealing the container to keep the product fresh.

One primary problem with currently available resealable containers is the inability to properly store the remainder of the product. More specifically, in circumstances when the product quality degrades with exposure to air after the container is initially opened, the air within a container, even though sealed, can cause the product to spoil. This is particularly evident when the container is an ice-cream container. The exposure of a large volume of air to the ice cream remaining in a typical container results in the formation of ice crystals on the surface of the ice cream.

Another challenge with currently available resealable containers occurs when a substantial portion of the product within a container is consumed. In this situation, a large container will be left substantially empty resulting in a significant amount of wasted space. This problem is particularly problematic when the container is stored in a location having limited space, such as a refrigerator or freezer.

In light of the above, it would be advantageous to provide a container that may be used to package goods for sale and consumption, and that can be made smaller as the goods are consumed in order minimize wasted storage space, facilitate access to the remaining goods, and minimize exposure to air within the container.

### SUMMARY OF THE INVENTION

The present invention includes a container that is re-sizable to accommodate a decreasing amount of product within the container. The bottom is formed with one or more circumferential strips that may be removed from the container to separate a portion of the bottom thereby decreasing the volume of the bottom. The lid may be placed on the remaining portion of the bottom to seal the remaining product within the container while minimizing exposure to air, and decreasing any wasted space.

In a preferred embodiment, the present invention is directed toward a product container, such as an ice cream container, having a bottom, and a sealing lid. In this embodiment, ice cream, for example, may be purchased from the store and transported in a suitably sized container. Once the ice cream is consumed to the point that the remaining ice cream is below one of the circumferential strips, the strip and the portion of the container above the strip may be removed leaving a smaller, more appropriately sized container. The sealing lid may be placed over the remaining portion of the container to seal the container while minimizing the air within the container, minimizing the storage space needed for the container.

Also, by decreasing the size of the container as the product is consumed, access to the remaining product is made easier. More specifically, using the ice cream container example, by decreasing the height of the container as the ice cream is consumed, it will be easier to scoop out the remaining ice cream.

### BRIEF DESCRIPTION OF THE DRAWINGS

The novel features of this invention, as well as the invention itself, both as to its structure and its operation, will be best understood from the accompanying drawings, taken in conjunction with the accompanying description, in which reference characters refer to similar parts, and in which:

FIG. 1 is a perspective view of the re-sizable container of the present invention showing a container base having multiple sections that are removable to change the size of the container as the product within the container is consumed, and having a lid sized to seal the container;

FIG. 2 is a perspective view of the re-sizable container of the present invention showing the container of FIG. 1 with a section removed to form a container having a smaller volume to contain the product within the appropriately sized container thereby minimizing exposure of air to the product and minimizing wasted storage space;

FIG. 3A is a cross-sectional view of the junction between two sections of the re-sizable container of the present invention attached together with a strip adhesively attached to the base and the section; and

FIG. 3B is a cross-sectional view of the junction between two sections of the re-sizable container of the present invention attached together with a strip having a removable centerline for separating the strip into two parts thereby separating the sections.

### DETAILED DESCRIPTION

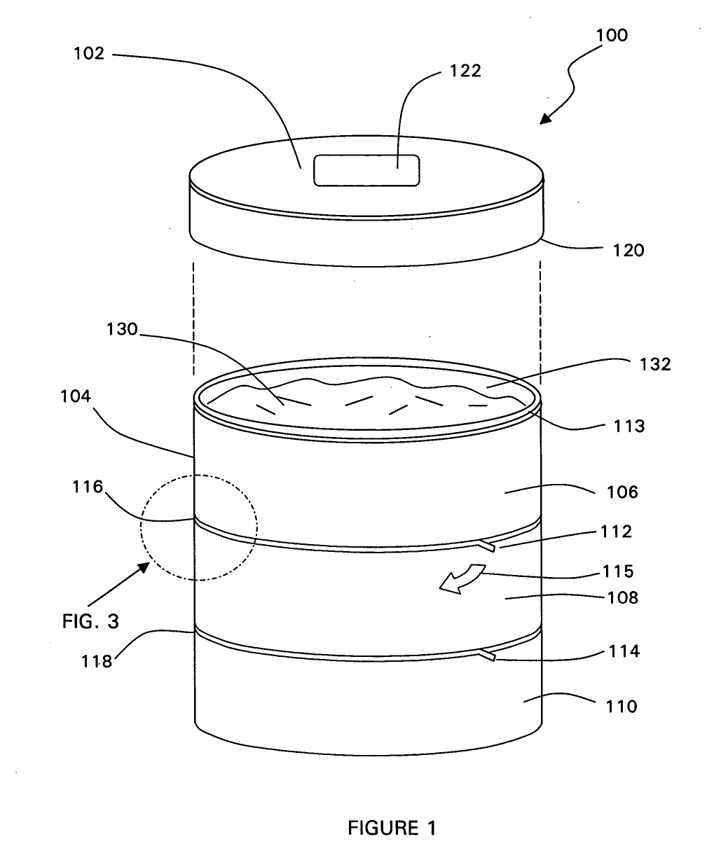

Referring initially to FIG. 1, the re-sizable container of the present invention is shown and generally designated 100. Re-sizable container 100 includes a top, or lid 102, and a bottom 104. In a preferred embodiment, bottom 104 includes one or more removable sections 106 and 108. These removable sections are separable at joints 116 and 118 by removing removable strips 112 and 114, respectively.

Re-sizable container 100 contains a product 130, such as ice cream, and may create an air chamber 132 between the product 130 and the lid 102. As shown by the dashed lines in FIG. 1, lid 102 may be lowered onto bottom 104 such that the rim 120 of the lid 102 seats firmly about the rim 113 of the bottom 104 to seal the container 100.

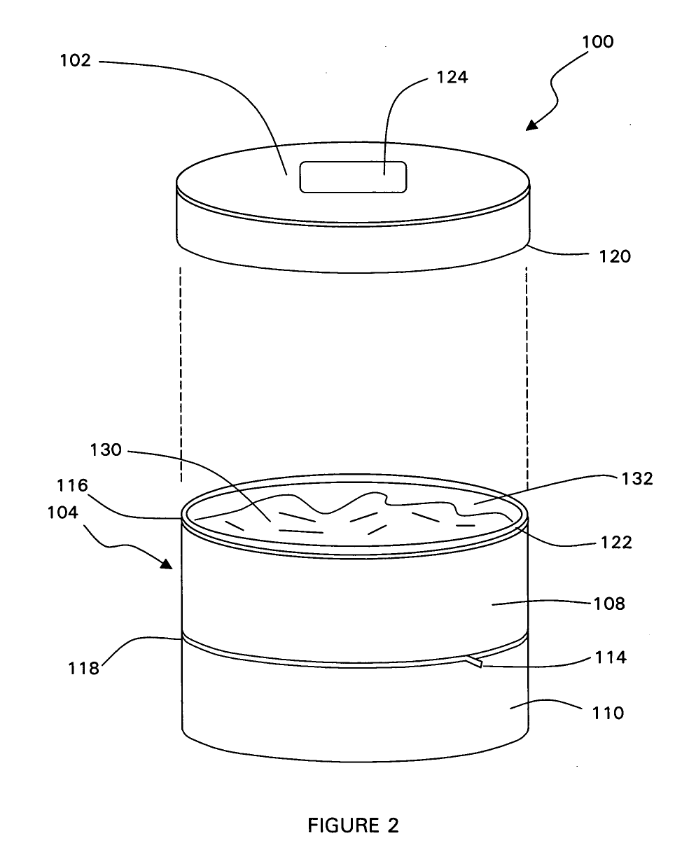

Referring now to FIGS. 1 and 2, the container 100 is shown in an alternative configuration following the removal of some of the contents of the container. More specifically, when the product 130 is consumed below the level of the first removable section 106, removable strip 112 may be pulled in direction 115 around the circumference of the container bottom 104 to separate section 106 from section 108 along joint 116. Once section 106 (shown in FIG. 1) is removed, lid 102 may be placed on rim 122 of section 108 to once again seal the contents of the container 100. As shown in this Figure lid 102 may be formed with a window 124 for viewing the content of the container 100.

By decreasing the size of the container in this manner, the air chamber 132 is minimized thereby improving the freshness of the product stored in the container 100. Moreover, by decreasing the height of the container 100 to correspond to the height of the product within the container, the access to the product is simplified. This is particularly so if the product is frozen ice cream or other solid or near solid products. As the product 130 is consumed further, section 108 may be removed from base 110 by the removal of removable strip 114 to further minimize the volume of container 100.

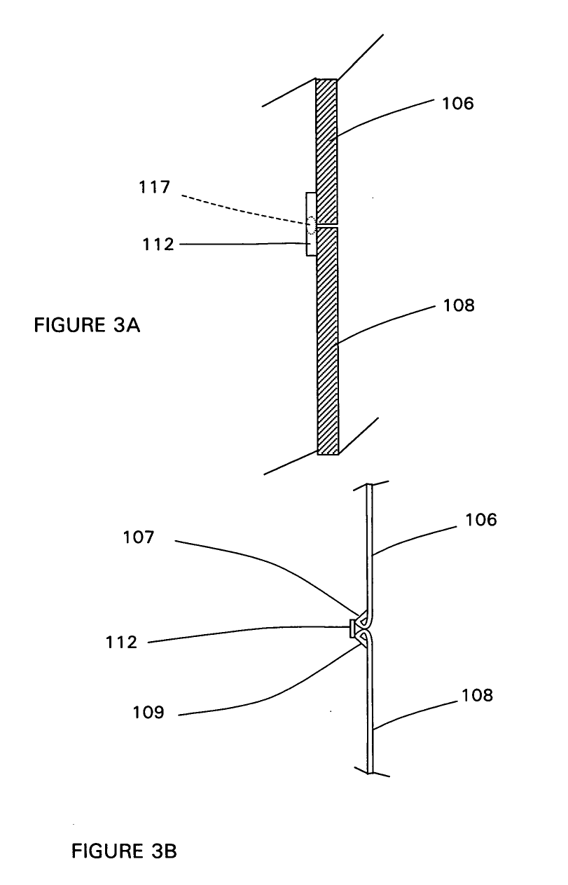

Referring now to FIGS. 3A and 3B, the details of the connection of section 106, 108, and 110 are shown. In FIG. 3A, section 106 is connected to section 108 with a strip 112, and section 108 is connected to section 110 with a strip 114. As shown in cross-section, the thickness of the sections 106 and 108 are substantially constant, and strip 112 is attached to the sections 106 and 108 using a suitable attachment method as is known in the art. Such attachment devices and methods include, but are not limited to, strip 112 being attached to the sections 106 and 108 with an adhesive. Alternatively, strip 112 may be sufficiently wide to extend from section 106 to section 108 and embody a removable centerline 117 (shown in dashed lines in FIG. 3A). This centerline 117 would tear through the longitudinal middle of the strip 112 to separate into two parts, thereby separating section 106 from section 108.

Referring to FIG. 3B, a vertical cross section of an alternative embodiment of sections 106 and 108 of container 100 are shown having rolled edges 107 and 109. An attachment strip 112 extends between edges 107 and 109 to attach sections 106 and 108. As strip 112 is removed along the circumference of container 100, section 106 is detached from section 108. A centerline (not shown in this Figure) may also be incorporated in the embodiment shown in FIG. 3B.

It is to be appreciated that the present invention is shown herein having multiple sections. However, it is also to be appreciated that the present invention is not limited to any particular number of sections, rather, other embodiments having different numbers of sections are fully contemplated herein. For instance, container 100 may be formed with one (1) section that is removable from a base section, but more or fewer sections could be used.

From the Figures discussed above, it is to be appreciated that a preferred embodiment of the present invention includes containers that are formed with a circular horizontal cross section, and having a cylindrical shape. However, such a shape is not a requirement of the present invention. In fact, other shapes are contemplated herein. For example, container 100 may be formed to have a rectangular or square horizontal cross sectional shape, so long as the horizontal cross section of the container is constant so that the lid will securely fit over the rim of each section. It is also to be appreciated that although the preferred embodiments described herein have been discussed as applied to an ice-cream container, the present invention is not limited to such containers. Rather, the present invention may be used in conjunction with virtually any product containers, including, but not limited to, yogurt and cottage cheese containers.

While the re-sizable container of the present invention as herein shown and disclosed in detail is fully capable of obtaining the objects and providing the advantages herein before stated, it is to be understood that it is merely illustrative of preferred embodiments of the invention and that no limitations are intended to the details of construction or design herein shown other than as described in the appended claims.

1. A re-sizable container, comprising:
a base having an upper rim;
a section having an upper rim and a lower rim, wherein said lower rim of said section is sized to correspond to said upper rim of said base;
an attachment device extending between said base and said section to retain said upper rim of said base adjacent said lower rim of said section; and
a lid sized to seal said upper rim of said section.

2. The re-sizable container of claim 1, wherein said upper rim of said base and said lower rim of said section are formed with a rolled edge.

3. The re-sizable container of claim 1, wherein said upper rim of said base and said lower rim of said section are formed with a constant cross-section.

4. The re-sizable container of claim 1, wherein said lid is formed with a rim sized to receive the upper rim of said section to establish a seal therewith.

5. The re-sizable container of claim 1, wherein said attachment device further comprises a strip.

6. The re-sizable container of claim 5, wherein said strip further comprises a centerline, said centerline removable from said strip to separate said strip into two parts.

7. The re-sizable container of claim 1, wherein said strip further comprises an adhesive securing said strip between said base and said section.

8. The re-sizable container of claim 1, wherein said lid further comprises a window.

9. A re-sizable container, comprising:
a base having an upper rim;
a section having an upper rim and a lower rim; and
an attachment means for attaching said base to said section.

10. The re-sizable container of claim 9, wherein said attachment means further comprises a strip.

11. The re-sizable container of claim 10, wherein said attachment means further comprises a centerline, said centerline removable from said strip to separate said strip into two parts.

12. The re-sizable container of claim 9, wherein said attachment means further comprises an adhesive securing said strip between said base and said section.

13. The re-sizable container of claim 9, wherein said container is formed to have a circular horizontal cross-section.

14. The re-sizable container of claim 9, wherein said container is formed to have a non-circular horizontal cross-section.

15. The re-sizable container of claim 9, wherein said container is formed to have a substantially rectangular horizontal cross-section.

16. The re-sizable container of claim 9, wherein said lid further comprises a window.

17. A method for optimizing the storage space of a product within a container, comprising the steps of:
providing a re-sizable container having a base, at least one section attachable to said base at a junction with an attachment device, and a lid sized to receive said section and establish a seal therewith, said container containing a product;
consuming a portion of said product wherein the level of said product within said container is less than said joint;
separating said section from said base by detaching said attachment device; and
placing said lid on said base to seal said product in said base.

18. The method of claim 17, wherein said container further comprises a strip extending between said base and said section, said method further comprises removing said strip to separate said base from said section.

19. The method of claim 17, wherein said container further comprises a strip extending between said base and said section and having a centerline, said method further comprises removing said centerline from said strip to separate said base from said section.
